(19) United States
(12) Patent Application Publication
(10) Pub. No.: US 2017/0176098 A1
(43) Pub. Date: Jun. 22, 2017

(54) SYSTEMS AND METHODS FOR AUTOMATED STARTUP OF AN AIR SEPARATION PLANT

(71) Applicant: L'Air Liquide, Societe Anonyme pour l'Etude et l'Exploitation des Procedes Georges Claude, Paris (FR)

(72) Inventors: Paul KONG, Sugarland, TX (US); Paul MARKENTELL, Spring, TX (US); Daniel THOUIN, Sugarland, TX (US); Yufeng QIAN, Houston, TX (US); Minh PHAM-HUY, Houston, TX (US); Wendy YIP, Sugarland, TX (US)

(73) Assignee: L'Air Liquide, Societe Anonyme pour l'Etude et l'Exploitation des Procedes Georges Claude, Paris (FR)

(21) Appl. No.: 14/978,974

(22) Filed: Dec. 22, 2015

(51) Int. Cl. F25J 3/02; G05B 15/02

(52) U.S. Cl. CPC F25J 3/0295; G05B 15/02

(57) ABSTRACT

A request to initiate startup of an air separation plant may be received, and, in response to receiving the request, startup information that identifies a sequence of steps to be automatically executed to start up the air separation plant is retrieved. Each step may be associated with a component of the air separation plant, and may be associated with an action and a set of permissives corresponding to the action. The set of permissives for each action may specify one or more parameters for controlling the execution of the corresponding action. After retrieving the startup information, the system may automatically initiate execution of the sequence of steps, and may monitor the execution of each of the steps. The system may determine, based on the monitoring, whether to modify a parameter specified by one of the permissives corresponding to an executed action.

### TECHNICAL FIELD

The present application is generally related to the technical field of control systems for processing gases, and more particularly to the technical field of air separation plant control systems.

### BACKGROUND OF THE INVENTION

Air separation plants operate to compress, liquefy, and distil air in order to separate its different components (e.g., oxygen, nitrogen, argon, etc.). Typically, an air separation unit is operated to produce one or more desired output gases and/or liquids (e.g., the components separated from air taken into the air separation plant) that may be used as an on-site source that provides the desired output gases and/or liquids to other equipment at the site. For example, an air separation plant may be located proximate to a methanol production facility, and may be used to generate oxygen that is consumed by the methanol production facility during the production of methanol. Additionally or alternatively, the air separation plant may be used as an off-site source that provides generated the output gases and/or liquids to equipment located remote to the air separation plant (e.g., via a pipeline, via a truck, etc.). For example, an air separation plant may be used to generate oxygen that is bottled and delivered to businesses operating in various technical fields, such as healthcare facilities, oil and gas production facilities, and the like.

### BRIEF SUMMARY OF THE INVENTION

The present disclosure provides for systems, methods, and computer-readable storage media for automating startup of an air separation plant. The startup of the air separation plant may involve executing a sequence of actions which are traditionally performed sequentially by a plant operator in a manual fashion. The automated startup may be facilitated by defining a sequence of steps, where each step is associated with one or more actions and one or more permissives. The one or more permissives may specify criteria for initiating one or more of the actions for a particular step of the sequence of steps. During execution of the automated startup sequence, one or more of the actions may be initiated concurrently (e.g., at the same time or substantially the same time) or partially concurrently (e.g., both actions are being executed at the same time although they may not have been started at the same time). This may reduce the total time required to complete the automated startup process relative to the traditional manual startup process where every action is performed manually. Additionally, during execution of the steps of the automated startup process, various characteristics and conditions may be monitored to dynamically identify optimizations or modifications to the startup process. Such optimizations or modifications may further reduce the duration of the startup process, or may increase the lifespan of one or more components or equipment of the air separation plant.

The foregoing has outlined rather broadly the features and technical advantages of the present invention in order that the detailed description of the invention that follows may be better understood. Additional features and advantages of the embodiments will be described hereinafter which form the subject of the claims of the present disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of the embodiments, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram illustrating various aspects of an exemplary embodiment of an automated process for starting up an air separation plant;

FIG. 2 is a block diagram of illustrating aspects of an air separation plant and a process control sequencer in accordance with one or more embodiments of the present disclosure;

FIG. 3 includes block diagrams illustrating various aspects of exemplary embodiments for tuning an action performed during an automated process for starting up an air separation plant;

FIG. 4 includes block diagrams illustrating various aspects of exemplary embodiments for tuning a sequence of steps executed during an automated process for starting up an air separation plant;

FIG. 5 is a block diagram of illustrating aspects of an exemplary graphical user interface (GUI) for monitoring and controlling an automated startup process for an air separation plant; and

FIG. 6 is a flow diagram of illustrating an exemplary method for automating startup of an air separation plant in accordance with one or more embodiments of the present disclosure.

### DETAILED DESCRIPTION OF THE INVENTION

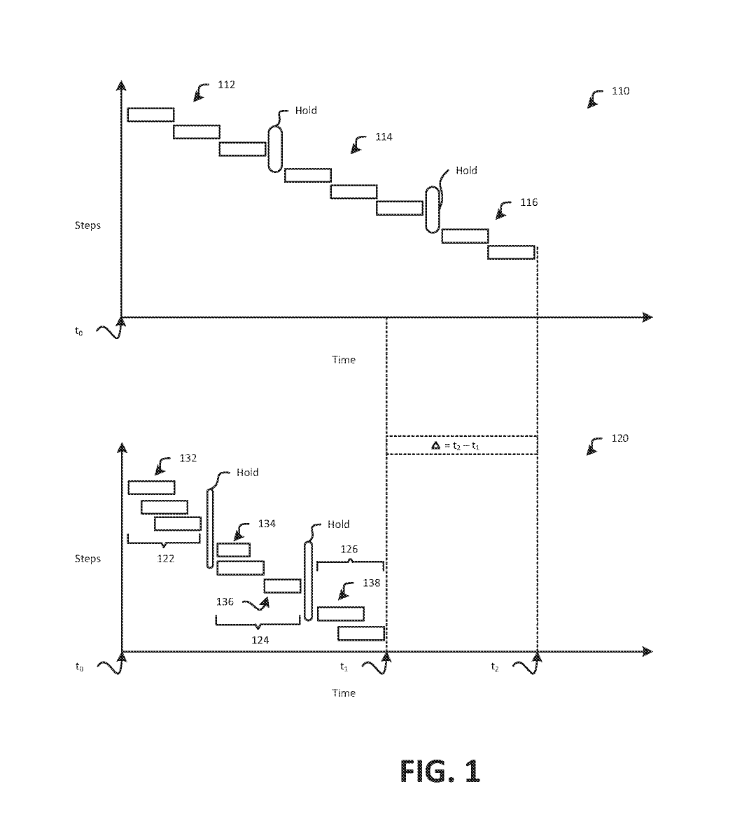

Referring to FIG. 1, a block diagram illustrating various aspects of an exemplary embodiment of an automated process for starting up an air separation plant is shown. In an upper portion of FIG. 1, a manual process for starting up an air separation plant is illustrated as a manual startup process 110, and in a lower portion of FIG. 1, an automated startup process for starting up an air separation plant in accordance with one or more embodiments of the present disclose is shown as an automated startup process 120.

As shown in FIG. 1, the manual startup process 110 may include a plurality of steps represented by horizontal rectangles, and may include one or more hold times represented by the vertical bars labeled “hold.” The manual startup process 110 may begin at a time t₀ and end at a time t₂, where t₂ represents a time when the manual startup process 110 has been completed and the air separation plant is in an operational state for outputting a supply of one or more desired gases and/or liquids (e.g., oxygen, nitrogen, argon, etc.) at a desired rate. As shown in FIG. 1, each of the steps of the manual startup process 110 is performed sequentially. For example, the manual startup process 110 may begin at time t₀ with the execution of a first sequence of steps 112, where each step of the first sequence of steps 112 is performed sequentially (e.g., a next step in the manual startup process 110 does not begin until a prior action has been completed). After the first sequence of steps 112 have been sequentially completed, a first hold time may occur. After the first hold time has completed, a second sequence of steps 114 may be sequentially completed followed by a second hold time. Subsequent to completion of the second hold time, a third sequence of steps 116 may be sequentially completed and the air separation plant may enter operational state for outputting a supply of one or more desired gases and/or liquids (e.g., at time t2). Presently, the manual startup process 110 is performed by plant operator who follows a set of procedures (e.g., the sequences of steps 112, 114, 116, etc.) to start various components of the air separation plant one piece of equipment at a time, which lengthens the time to complete the startup of the air separation plant. Additionally, the performance of the manual startup process 110 is subject to human error, and achieving consistent and reliable startups may be difficult depending on the experience level of the plant operator, the attention paid by the plant operator during execution of each step of the manual startup process 110, or other factors.

As shown in FIG. 1, the automated startup process 120 may include a plurality of steps represented by horizontal rectangles, and may include one or more hold times represented by the vertical bars labeled “hold.” In an embodiment, the plurality of steps represented by the automated startup process 120 may be the same steps represented by the plurality of steps described above with respect to the manual startup process 110. However, as described in more detail below, the steps of the automated startup process 120 may be performed more efficiently and consistently according to one or more embodiments of the present disclosure. The automated startup process 120 may begin at a time t₀ and end at a time t₁, where t₁ represents a time when the automated startup process 120 has been completed and the air separation plant is in an operational state for outputting a supply of one or more desired gases and/or liquids at a desired rate. As shown in FIG. 1, the steps of the automated startup process 120 may be performed at least partially concurrently (e.g., a subsequent step may be started prior to completion of a previous step), as shown at 132 and 138, concurrently (e.g., two or more steps may be started at substantially the same time), as shown at 134, or sequentially (e.g., a subsequent step may be started upon completion of a previous step), as shown at 136. For example, the automated startup process 120 may begin at time t₀ with the execution of a first sequence of steps 122. As shown at 132, the steps of the first sequence of steps 122 may be performed partially concurrently. That is, two or more of the steps of the first sequence of steps 122 may be executed simultaneously, although not necessarily starting or ending at the same time. This is in contrast to the manual startup process 110 in which all of the steps are performed sequentially (e.g., none of the steps of the manual startup process 110 are executed simultaneously).

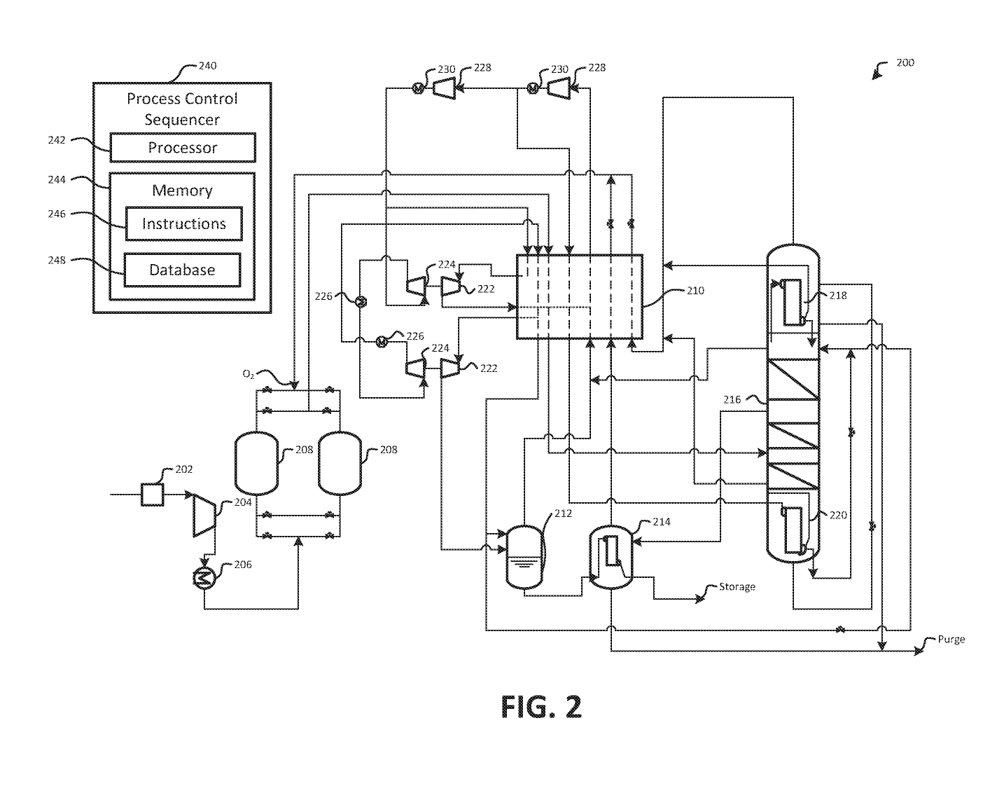

After the first sequence of steps 122 has been completed, a first hold time may occur. After the first hold time has completed, a second sequence of steps 124 may be completed followed by a second hold time. As shown in FIG. 1, at 134, a portion of the second sequence of steps 124 may be initiated concurrently (e.g., initiated at the same, or substantially the same, time, but not necessarily completed at the same, or substantially the same, time), while another portion of the sequence of steps 124 may be executed, at 136, sequentially (e.g., initiating the other portion of the second sequence of steps 124 may be dependent upon completion of one or more prior steps of the second sequence of steps 124). Subsequent to completion of the second hold time, a third sequence of steps 126 may be initiated, at 138, at least partially concurrently. When the third sequence of steps 126 is complete, at time t₂, the air separation plant may enter an operational state for outputting a supply of one or more desired gases. As illustrated in FIG. 1, starting up the air separation plant according to the automated startup process 120, as opposed to the manual startup process 110, may result in a reduced amount of time (Δ) required to complete the startup process, where Δ=t₂−t₁. Further, due to the automation of the automated startup process 120, the reliability and consistency of the startup of the air separation plant is increased (e.g., because the startup process is not dependent upon the skill level of the plant operator, and is not subject to human errors in executing the steps of the startup process). Additional advantages and features of one or more embodiments of the present disclosure are described in more detail below with reference to FIG. 2.

In an embodiment, the hold times (or delays) may be dynamically adjusted to lengthen or shorten the duration of the hold times based on observations made with respect to the air separation plant components during the startup process, as described in more detail below. In FIG. 1, the hold times utilized by the automated startup process 120 have been decreased, as indicated by the widths of the vertical bars shown in the automated startup process 120 being thinner than the vertical bars shown in the manual startup process 110. Additionally, as shown in FIG. 1 with respect to the automated startup process 120, the hold times may be decreased (or increased) by varying amounts. This is illustrated in FIG. 1 by the vertical bar corresponding to the hold time between the first sequence of steps 122 and a second sequence of steps 124 being thinner (e.g., shorter in duration) than the vertical bar corresponding to the hold time between the second sequence of steps 124 and the third sequence of steps 126. It is noted that in some operational scenarios, the duration of one or more hold times may be increased, as described in more detail below. In an additional or alternative embodiment, one or more steps in the sequence of steps may be dynamically adjusted to lengthen or shorten the duration of the one or more steps based on observations made with respect to the air separation plant and its components during execution of the automated startup process 120, as described in more detail below.

Referring to FIG. 2, a block diagram of illustrating aspects of an air separation plant and a process control sequencer in accordance with one or more embodiments of the present disclosure is shown as an air separation plant 200. As shown in FIG. 2, in an embodiment, the air separation plant 200 may include an air filter 202, a main air compressor (MAC) 204, a MAC aftercooler 206, one or more air purification vessels 208, a cycle exchanger 210, a liquid nitrogen (LIN) separator 212, a LIN subcooler 214, a pressure column 216, a main vaporizer 218, a rich liquid reboiler 220, one or more nitrogen expansion turbines 222, one or more nitrogen turbine boosters 224, one or more booster aftercoolers 226, one or more recycle compressors 228, one or more recycle compressor aftercoolers 230.

The air filter 202 may be configured to remove dust and other solid particles from intake air drawn into the air separation plant 200 by the MAC 204. The MAC 204 may be configured to draw intake air through the air filter 202 and output compressed air, which is provided to the MAC aftercooler 206. The MAC aftercooler 206 may be configured to cool the compressed air output by the MAC 204 and to remove moisture. The one or more air purification vessels 208 may be configured to remove carbon dioxide and other hydrocarbons present in the compressed air stream and to remove any remaining moisture present in the compressed air stream. The cycle exchanger 210 may operate as a heat exchanger that cools the compressed air stream that has been purified by the one or more air purification vessels 208. The one or more nitrogen expansion turbines 222 and the one or more nitrogen turbine boosters 224 may be configured to generate a stream of nitrogen rich gas that may be provided to the LIN separator 212. The one or more booster aftercoolers 226 may be configured to cool the streams of nitrogen rich gas generated by the one or more nitrogen expansion turbines 222 and the one or more nitrogen turbine boosters 224 prior to providing the nitrogen rich gas to the LIN separator 212. The LIN separator 212 may be configured to separate the nitrogen rich gas generated by the one or more nitrogen expansion turbines 222 and the one or more nitrogen turbine boosters 224 to produce a stream of LIN, and the LIN subcooler 214 may be configured to cool the stream of LIN generated by the LIN separator 212. The cooled LIN stream may be provided to storage, and byproducts of the cooling process may be purged. The one or more recycle compressors 228 and one or more recycle compressor aftercoolers 230 may be configured to receive a second output stream (e.g., a nitrogen rich vapor) from the LIN separator 212 and a nitrogen rich vapor from the pressure column 216, and may feed the output stream to the one or more nitrogen expansion turbines 222 and the one or more nitrogen turbine boosters 224. The pressure column 216, the main vaporizer 218, and the rich liquid reboiler 220 may be configured to separate the compressed air stream into its various components (e.g., oxygen (O₂), nitrogen, etc.).

Additionally, the air separation plant 200 includes a process control sequencer 240. The process control sequencer 240 may include a processor 242, a memory 244, and other components (e.g., a communication interface for sending and receiving information via a network, a display device, one or more input devices, etc.) not shown in FIG. 2. The memory 244 may store instructions 246 that, when executed by the processor 242, cause the processor 242 to perform operations for starting up the air separation plant 200, as described with reference to FIGS. 1-4. Additionally, the memory 244 may store a database 248 that includes information for controlling the automated startup of the air separation plant 200, as described in more detail below. In an additional or alternative embodiment, the database 248 may be stored at a memory located external to the process control sequencer 240, such as at a network attached storage (NAS) device, an external storage device, or another form of storage external to the process control sequencer 240.

During operation, the process control sequencer 240 may be configured to control automated startup of the air separation plant 200. For example, the process control sequencer 240 may receive a request to initiate startup of the air separation plant 200. In an embodiment, the request may be received in response to an input received via a graphical user interface (GUI) presented at a display device (not shown in FIG. 2) coupled to the process control sequencer 240. In response to receiving the request, the process control sequencer may retrieve startup information for the air separation plant 200. In an embodiment, the startup information may be stored at the database 248. The startup information may include information identifying a sequence of steps to be automatically executed to start up the air separation plant 200. In an embodiment, each step of the sequence of steps may be associated with a component of the air separation plant 200. In an embodiment, the startup information may include an action to be automatically completed for each step of the sequence of steps. In an embodiment, one or more of the steps may be associated with a set of one or more permissives. In an embodiment, the set of permissives for a step may specify one or more timing parameters for controlling the execution of the corresponding action(s). For example, the one or more timing parameters may include timing parameters that specify timing constraints for when a corresponding action or set of actions may be executed (e.g., concurrently, partially concurrently, sequentially, etc. with respect to another action or step in the sequence of steps) or timing constraints for when a step of the sequence may be initiated, one or more process parameters indicating a state of one or more components of the air separation plant 200 (e.g., a threshold pressure level for an input or output of a component, whether another component is running at a steady state of operation, etc.), and the like. Additionally, the startup information may include information indicating an order of execution for the sequence of steps.

In an embodiment, a step may be associated with a delay timer that may be activated upon initiation of the step. If the delay timer expires prior to all of the permissives for the next step in the sequence of steps being satisfied, the process control sequencer 240 may place the automated startup process on hold. In an embodiment, the process control sequencer 240 may impose the hold until all of the permissives for the next step in the sequence are satisfied. In an embodiment, an operator may override the automated startup sequence by providing an override command to the process control sequencer 240. In an embodiment, the operator may impose a hold at any time by providing an appropriate command to the process control sequencer 240. This may enable the operator to halt the automated startup sequence if the operator detects an anomaly during the startup sequence, or for other purposes. In an embodiment, the operator may further provide an abort command to the process control sequencer 240 to abort the automated startup sequence. When the abort command is provided to the process control sequencer 240, the automated startup process may be terminated in its current state, and the remaining startup process may be carried out manually by the plant operator from thereon. In an embodiment, the air separation plant 200 may be configured with plant safety interlocks. If any of the plant safety interlocks are tripped during execution of the various steps of the automated startup sequence, the process control sequencer 240 may immediately terminate the automated startup sequence to put the plant in a safe state.

During execution of the various steps of the automated startup sequence, the process control sequencer 240 may monitor one or more permissives or parameters to determine whether values of the one or more permissives or parameters satisfy the threshold values. If the process control sequencer 240 determines that the one or more permissives or parameters passed (e.g., satisfied the threshold values), the process control sequencer may initiate execution of a next step in the automated startup sequence.

After retrieving the setup information, the process control sequencer 240 may automatically initiate execution of the sequence of steps. A high level description of executing a sequence of steps using an automated startup process according to one or more embodiments of the present disclosure is provided below. It is noted that the exemplary description provided below is provided for purposes of illustration, rather than by way of limitation, and that additional or alternative steps, actions, permissives, etc. may be utilized in an automated startup process for an air separation plant, but are not included herein for simplicity of the present disclosure.

In an embodiment, the startup information may include information indicating a first step in the sequence of steps, where the first step may include verifying that one or more permissives for starting the automated startup process are satisfied. In an embodiment, the one or more permissives for starting the automated startup process may include verifying that the components of the air separation plant are ready to start. This may include verifying that the inlet guide vanes (IGV) and anti-surge valves of the MAC and recycle compressors are in proper positions, outlet pressure at the nitrogen turbines and nitrogen turbine boosters is low, and that alarms and/or interlocks associated with the various components of the air separation plant have been cleared. If all of these permissives pass, the process control sequencer may initiate a first action in response to receiving a command to initiate the automated startup sequence. The first action may be associated with one or more permissives, which may include verifying that the pressure at the inlet of recycle compressor is within a defined threshold psia (pounds per square inch absolute). In an embodiment, the threshold psia may be greater than 18 but less than 22. If the psia at the inlet is within this threshold, the first action associated with the permissives may be performed.

After completing the first action, the process control sequencer may determine a second step of the sequence of steps based on the startup information. The second step in the sequence of steps may include performing a plurality of actions, which may include: 1) ramping up outputs of IGV controllers of the MAC and recycle compressors to first positions; and 2) ramping up the output rates of the MAC and recycle compressors to a second position. In an embodiment, the initial IGV outputs may be set to 0%, and, after the MAC and recycle compressors are started up, the IGV may be ramped up to the first outputs of fifteen percent (15%) and twenty percent (20%), respectively. In an embodiment, the second IGV outputs may be thirty five percent (35%) and twenty percent (20%), respectively. In an embodiment, the second step of the sequence of steps may include determining whether the MAC and recycle compressors are ready to start (e.g., are the inlet valves to both the MAC and recycle compressors open).

Upon completing the second step, the process control sequencer may determine a third step of the sequence of steps based on the startup information. The third step in the sequence of steps may include setting a plurality of valves. In an embodiment, setting the plurality of valves may include closing vent or recirculation valves associated with the MAC and recycle compressor(s), opening or closing one or more valves (e.g., inlet and outlet valves) of the pressure column, the LIN subcooler, the LIN separator, the cycle exchanger, etc., setting a temperature control valve of the LIN subcooler, other valves of the various components of the air separation plant, or a combination thereof. In an embodiment, the third step may be associated with a timing parameter that indicates that each of the plurality of valves may be set concurrently. This may significantly reduce the amount of time required to startup the air separation plan relative to a manual startup process. Thus, setting each of the valves concurrently using an automated startup process according to embodiments of the present disclosure may reduce the amount of time required to complete the startup process.

Upon completing the third step, the process control sequencer may determine a fourth step of the sequence of steps based on the startup information. The fourth step in the sequence of steps may include loading (e.g., allowing pressure to build up at) the MAC and recycle compressors. For example, the MAC may be loaded by opening up guide vanes upstream of the MAC and closing a downstream vent valve (e.g., an anti-surge valve). Together, the guide vanes and the vent valve may control the amount of air provided to an air purifier (e.g., the one or more air purification vessels 208 of FIG. 2). This allows the MAC to build up pressure for generating the compressed air stream that will be subsequently provided to other components of the air separation plant that separate the compressed air stream into its component elements (e.g., oxygen, nitrogen, etc.). In an embodiment, the loading of the compressors may include the following actions: ramping up the IGVs of the MAC and recycle compressors; closing the vent valves of the MAC and the anti-surge valve of the recycle compressor; configuring a flow rate limiter associated with an outlet of the pressure column; or a combination thereof. Further, the loading of the compressors may be associated with a ramp parameter that ramps the IGV output of the compressors from the level set in the second step to a third output. For example, as explained above, in an embodiment, upon starting up the MAC and recycle compressors, the compressors may be ramped up to a second output (e.g., thirty five percent (35%)). During the fourth step, the compressors may be further ramped up from the second output rate to the third output. In an embodiment, the third output rate may be a fifty percent (50%) output. In an embodiment, the fourth step may be associated with a permissive that includes a timing parameter. For example, in an embodiment, the permissive for the fourth step may indicate that the fourth step is to be executed sequentially with respect to the third step.

Upon completing the fourth step, the process control sequencer may determine a fifth step of the sequence of steps based on the startup information. The fifth step in the sequence of steps may include starting and loading (e.g., allowing pressure to build up at) the nitrogen turbines and the nitrogen turbine boosters. In an embodiment, the loading of the nitrogen turbines and the nitrogen turbine boosters may include the following actions: starting the nitrogen turbines and the nitrogen turbine boosters; opening IGVs for the nitrogen turbines to a first level; and ramping the output IGVs for the nitrogen turbines to a second level. In an embodiment, outputs for the nitrogen turbines may be ramped up to different outputs. For example, the initial outputs for both the nitrogen turbines may be set to zero percent (0%), and then the first nitrogen turbine may be ramped to a thirty five percent (35%) output and the second nitrogen turbine may be ramped to a twenty five percent (25%) output. In an additional or alternative embodiment, the outputs for both nitrogen turbines may be ramped up to the same output. In an embodiment, the fifth step may further include ramping down (e.g., closing) the recycle valves of the nitrogen turbine boosters to a desired level after ramping up the IGV outputs for the nitrogen turbines. In an embodiment, the fifth step may be associated with a permissive that includes timing parameters. For example, the timing parameters may indicate that the fifth step cannot be initiated until completion of the fourth step, and that the recycle valves are to be ramped down upon ramping up the IGV outputs for the nitrogen turbines. Additionally, the permissives for the fifth step may further indicate that the fifth step is not to be initiated until the nitrogen turbines and the nitrogen turbine boosters have been started. This may prevent damage to the nitrogen turbines and the nitrogen turbine boosters.

Following the initial loading of the nitrogen turbines and the nitrogen turbine boosters, as described above with respect to the fifth step, the process control sequencer may determine a sixth step of the sequence of steps based on the startup information. In an embodiment, the sixth step may include performing a second loading of the MAC, the recycle compressors, the nitrogen turbines, and the nitrogen turbine boosters. During this step, the loading may be ramped up at each of the components such that each of the components is operating at a capacity suitable for production of one or more target outputs (e.g., oxygen, nitrogen, etc.) of the air separation plant. In an embodiment, the sixth step may be associated with a permissive that includes timing parameters. For example, the timing parameters may indicate that the sixth step cannot be initiated until completion of the fifth step. Additionally, the permissives for the fifth step may further indicate that the sixth step is not to be initiated until the LIN separator has reached a threshold level of operation. In an embodiment, the threshold level of operation associated with the LIN separator may be 10%.

Upon completing the sixth step, the process control sequencer may determine a seventh step of the sequence of steps based on the startup information. In an embodiment, the seventh step may include transitioning the air separation plant from a startup operational state to a normal operation state. In an embodiment, transitioning the air separation plant from the startup operational state to the normal operation state may include initializing monitoring of states and temperatures for various stages/components of the air separation plant. During the monitoring, if states or temperatures outside of desired states of temperatures are observed, one or more actions may be taken. In an embodiment, the one or more actions may include ramping one or more controllers of the air separation plant up or down, which may eliminate the detected anomaly. In an embodiment, the controller ramp rates and their target settings and associated timers, as used during execution of the automated startup sequencer, may be dynamically adjustable (tunable) based on observations, as described in more detail below. This provides a convenient way to optimize or shorten the test time during system commissioning as well as automated startup time. Other actions may also be taken, such as to trigger one or more alerts to the plant operator, placing one or more components of the air separation plant on hold, etc. In an embodiment, the seventh step may be associated with a permissive that indicates the air separation plant may be transitioned from the startup operational state to the normal operational state when the sixth step has completed and the LIN separator level is operating above a threshold level.

Referring back to FIG. 2, during the execution of the sequence of steps, the process control sequencer 240 may monitor execution of each of the steps. Based on information obtained during the monitoring, a determination may be made regarding whether to modify a parameter specified by one of the permissives or an executed action. For example, in an embodiment, after the MAC is started, a delay may be initiated to allow the MAC to warm up (e.g., allow the MAC to reach an operational state suitable for continuing with the automated startup sequence). In an embodiment, the delay may be set to a first amount of time (e.g., 30 seconds). Over the course of operation of the air separation plant, the duration of the delay may be adjusted or “tuned.” For example, a graphical user interface (GUI) presented at a display device coupled to a process control sequencer may present information indicating the operational status of the MAC, such as RPM information associated with the MAC, input/output flow rates and/or upstream/downstream pressures associated with the MAC. If it is observed during the monitoring that the MAC is operating at a target RPM rate, and the input/output flow rates and/or upstream/downstream pressures of the MAC satisfy threshold levels prior to the expiration of the delay, the duration of the delay may be reduced. Alternatively or additionally, if it is observed during the monitoring that the MAC is not operating at a target RPM rate, or that the input/output flow rates and/or upstream/downstream pressures of the MAC do not satisfy threshold levels prior to the expiration of the delay, the duration of the delay may be increased.

The process control sequencer may store any modifications to the one or more permissives or executed actions in the database 248. For example, the database 248 may store one or more profiles associated with various configurations of the startup information. A default profile may include permissives and actions to be executed that have default values determined based on the configuration of the air separation plant. The particular parameters of the default profile may be set independent of factors (e.g., ambient conditions, utility conditions, equipment characteristics and sizes, instrumentation characteristics, control valve characteristics and sizes, modes of operation, etc.) that may affect operating of the air separation plant. Over the course of its life, the air separation plant may be started and stopped many times. During each startup sequence, the process control sequencer 240 may generate information representative of monitored conditions observed during the automated startup sequence. Such information may be stored in the database 248 and may be used to generate additional profiles that may be used to configure the automated startup sequence based on currently observed conditions of the air separation plant.

For example, a first profile may include modifications to the automated startup sequence that were determined during one or more executions of the automated startup sequence in cold weather conditions. The modifications may include longer delays and/or hold times relative to the default profile to allow various components of the air separation plant to warm up before being placed in a normal operating state. Upon receiving the command to begin the automated startup sequence, the process control sequencer may determine ambient conditions at the location of the air separation plant, and, if the ambient conditions match the ambient conditions associated with the first profile to within a threshold tolerance, the process control sequencer may initiate the automated startup sequence based on the first profile. This may prevent damage to the various components of the air separation plant, and increase the lifespan of the components, which in turn reduces the costs to operate the air separation plant.

As another example, a second profile may include modifications to the automated startup sequence that were determined during one or more executions of the automated startup sequence in warm weather conditions. The modifications may include shorter delays and/or hold times relative to the default profile, but may still be sufficient to allow various components of the air separation plant to warm up before being placed in a normal operating state. Upon receiving the command to begin the automated startup sequence, the process control sequencer may determine ambient conditions at the location of the air separation plant, and, if the ambient conditions match the ambient conditions associated with the second profile to within a threshold tolerance, the process control sequencer may initiate the automated startup sequence based on the second profile. This may shorten the startup time without compromising the lifespan of the components, which in turn reduces the costs to operate the air separation plant 200.

As yet another example, instrumentation characteristics (e.g., control valve characteristics) may affect the various automated startup sequence profiles, such as to affect the speed at which a valve may be opened. This may impact transient time of the air separation plant. As a further example, nitrogen pressure supplied to the recycle compressor prior to its startup may affect the amount of time required to pressurize the suction pressure to a threshold level suitable to startup the recycle compressor (e.g., lower the nitrogen pressure may increase the time required to pressurize the suction pressure up to the threshold level suitable for starting up the recycle compressor). In an embodiment, if the process control sequencer determines that there is low nitrogen pressure being supplied to the recycle compressor, the process control sequencer may select a profile from the database that provides an increased delay prior to starting the recycle compressor, so as to enable the pressure to reach the threshold level. As another further example, one or more components of the air separation plant may be started from a warm state vs. a cold state (e.g., ambient temperature vs. normal cryogenic temperature). This may affect the load up rate of nitrogen turbines and nitrogen turbine boosters due to thermal constraints, and ultimately, transient time in the startup process. If the process control sequencer 240 detects a warm state (e.g., temperature is greater than a defined threshold value) on one or more components in air separation plant 200, it may select a profile from the database that provides a slower load up rate of nitrogen turbines and nitrogen turbine boosters. This may increase the lifespan of the components, which in turn reduces the costs to operate the air separation plant 200.

It is noted that each of the various profiles stored in the database 248 may account for multiple different factors that affect the automated startup sequence. For example, the second profile described above may include information for configuring the automated startup sequence with a first delay for starting the recycle compressor when there is low nitrogen pressure being supplied to the recycle compressor, and a second delay for starting the recycle compressor when there is a higher nitrogen pressure being supplied to the recycle compressor. Thus, upon receiving the command to begin the automated startup sequence, the process control sequencer may first determine ambient conditions at the location of the air separation plant, and, if the ambient conditions match the ambient conditions associated with the second profile to within a threshold tolerance, the process control sequencer may then configure the automated startup sequence based on additional information, such as the level of nitrogen pressure being supplied to the recycle compressor and/or a state of one or more components with respect to temperature. The various profiles stored in the database 248 may correspond to optimized automated startup sequences that have been tailored to particular operating environments, characteristics, equipment combinations, and the like. Thus, given a set of observed conditions, the process control sequencer 240 may select a profile for an automated startup sequence that has been appropriately optimized for the observed conditions.

From the aspects of the process control sequencer 240 described above, it has been shown that the process control sequencer 240 of embodiments provides for intelligent and dynamic configuration of an automated startup sequence. It is noted that using the process control sequencer 240 of the present disclosure may further improve the startup operation of the air separation plant by reducing or eliminating the inconsistencies that are dependent upon the skill and experience level of the plant operator. For example, because the process control sequencer 240 of embodiments is configured to dynamically and automatically configure various parameters of the automated startup sequence without intervention by the plant operator, the skill level required for performing the automated startup sequence may be reduced without significantly impacting the reliability and consistency of executing the startup sequence.

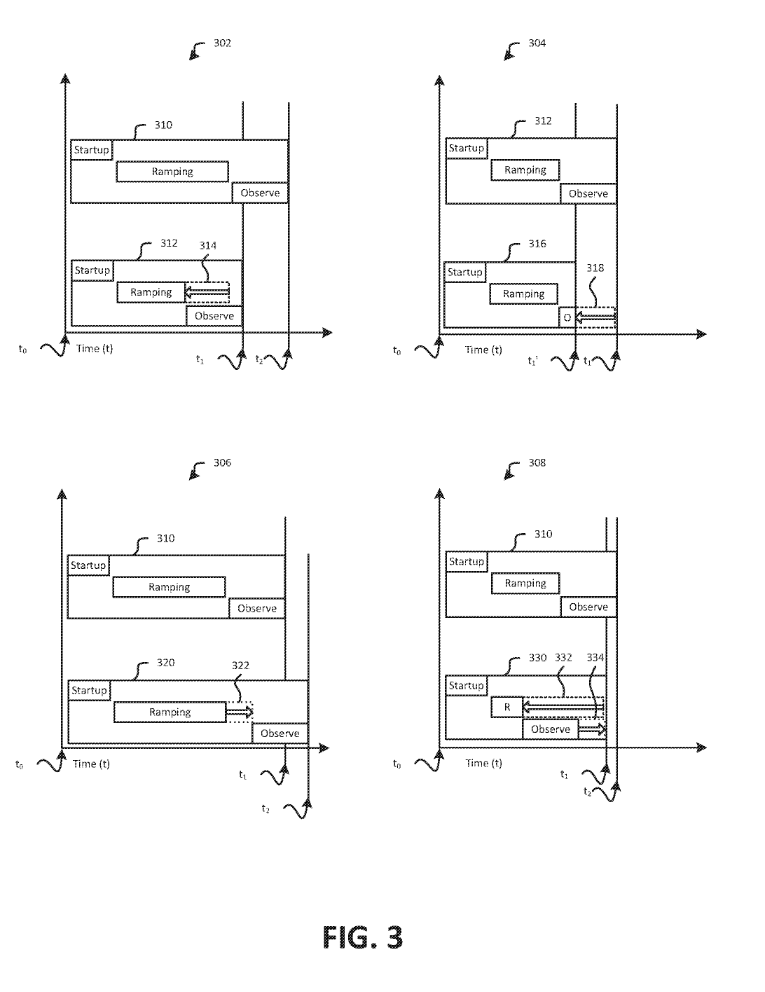

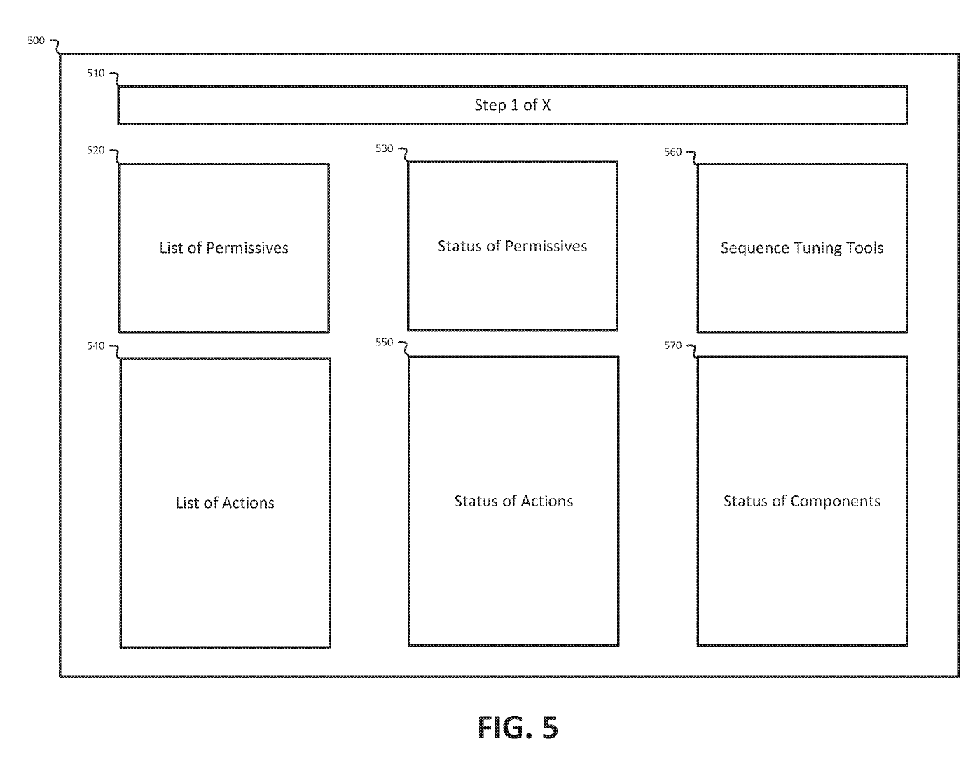

Referring to FIG. 3, block diagrams illustrating various aspects of exemplary embodiments for tuning an action performed during an automated process for starting up an air separation plant are shown. In FIG. 3, at 302, an step 310 is shown as including various actions to be performed during an automated startup sequence, such as the automated startup sequence operations described with reference to FIG. 2. As shown in FIG. 3, in an embodiment, the step 310 may include a startup action (e.g., starting a component of the air separation plant, such as the MAC, etc.), a ramping action (e.g., ramping the RPMs of the MAC, ramping a valve open or close, etc.), and an observation action (e.g., observing that the component that has been ramped up/down by the ramping action is in a steady state of operation. As shown in FIG. 3, the step 310 may be initiated at a time t₀ and may be completed at a time t₂. During execution of the step 310, a process control sequencer (e.g., the process control sequencer 240 of FIG. 2) may monitor one or more components and/or component characteristics (e.g., pressure at a particular valve, temperature of the air stream, etc.) affected by the actions being performed, and may initiate presentation of information representing the monitored components and/or component characteristics at a graphical user interface, as described in more detail with reference to FIG. 5. Based on the observations, the actions may be altered or “tuned.” For example, the observations may indicate that the ramping action may modified such that the ramping rate is increased (e.g., the duration of the ramping action is reduced), as indicated at 314. By reducing the ramping rate the observation action can be performed sooner. For example, the untuned step 310 may be completed at a time t₂, whereas the step 312, which has been tuned to increase the ramping rate, may be completed at a time t₁, where t₁−t₀<t₂−t₀ (i.e., the tuned step 312 is completed sooner than the untuned step 310).

Additionally, further tuning may occur based on observations made during subsequent startup operations executing a step that has been tuned. For example, at 304, the tuned step 312 has been further tuned to reduce the duration of the observation action, as indicated at 318. This may occur, for example, when it is observed that one or more components affected by the actions performed during execution of the tuned step 312 are in a steady state of operation prior to the expiration of a delay associated with the observation action. Thus, after a step in the startup sequence has been optimized or tuned, additional tuning may occur to further reduce the time required to complete the steps of the startup sequence. This is illustrated in FIG. 3 where the tuned step 312 starts at time t₀ and ends at time t₁, and the tuned step 316 starts at time t₀ and ends at time t₁′, where t₁′−t₀<t₁−t₀. Accordingly, the steps of the startup sequence may be optimized or tuned incrementally (e.g., a first tuning may occur during a first execution of the startup sequence and additional tuning may occur during subsequent executions of the startup sequence). This allows the actions/steps of the startup sequence to be tuned based on real-time changes to conditions (e.g., weather conditions, equipment conditions, etc.) at the air separation plant as observed during execution of the startup sequence. In an embodiment, this tuning process may generate profiles for various optimizations to the startup sequence that can be configured based on conditions observed at the air separation plant, as described above with respect to FIG. 2.

In an additional or alternative embodiment, tuning a step in the startup sequence may increase the duration of time required to complete a step. For example, at 306, the step 310 and a step 320 are shown. As illustrated in FIG. 3, the actions performed during execution of the step 320 are the same as the actions performed during execution of the step 310, however the step 320 has been tuned to decrease the ramping rate (e.g., the duration of the ramping action is increased), as indicated at 322. Tuning the step 310 in this manner may occur in response to changes observed at the air separation plant or in response to other factors. For example, the ramping rate corresponding to the step 310 may be configured for a first temperature range, and the “tuned” ramping rate corresponding to the step 320 may be configured for a second temperature range that is colder than the first temperature range. By tuning the ramping rate to adjust for colder temperatures, the likely hood that equipment is damaged may be reduced or eliminated.

In another additional or alternative embodiment, multiple actions may be tuned in response to observations made during a single execution of the startup sequence. For example, at 308, the step 310 and a step 330 are shown. The step 330 has been tuned to decrease the ramping rate, as indicated at 332, and has also been tuned to increase the duration of the observation action, as indicated at 334. One reason that such a tuning may occur is that, when the ramp rate for a component is initially increased, the duration of the observation action may be increased to provide more time to observe the impact of the increased ramp rate on one or more components of the air separation plant. If the impact does not negatively affect the one or more components, the duration of the observation action may be subsequently decreased by further tuning. It is noted that although the embodiment illustrated at 308 shows tuning of multiple actions by decreasing an amount of time to execute a first action (e.g., the ramping action) and increasing an amount of time to execute a second action (e.g., the observation action), in other embodiments, multiple actions may be tuned to increase/decrease their duration. Further, although the embodiment illustrated at 308 shows that multiple actions may be tuned while reducing the total time to complete the step 330 relative to the time to complete the step 310, in other embodiments the duration of step 330 (i.e., a step in which multiple actions are tuned) may increase relative to the duration of the step 310.

It is noted that in some embodiments, a sequence step may include additional actions (e.g., actions that are additional to the startup action, the ramping action, and the observation action) other than those illustrated in FIG. 3, may include less actions (e.g., does not include a ramping step, etc.) than those illustrated in FIG. 3, and/or may include different actions (e.g., actions that are different to the startup action, the ramping action, and the observation action) than those illustrated in FIG. 3. From the above it has been shown that tuning an automated startup sequence according to one or more embodiments of the present disclosure may reduce the amount of time required to complete the startup sequence, and may further reduce or eliminate the likelihood that components of the air separation plant are damaged by dynamically adjusting the startup sequence based on real-time conditions (e.g., equipment conditions, weather conditions, etc.) present at the air separation plant during execution of the automated startup sequence. Thus, one or more of the disclosed embodiments improve the functioning of the air separation plant itself, and improve the execution of the sequence of steps required to start up the air separation plant relative to the manual startup process presently used to start up an air separation plant.

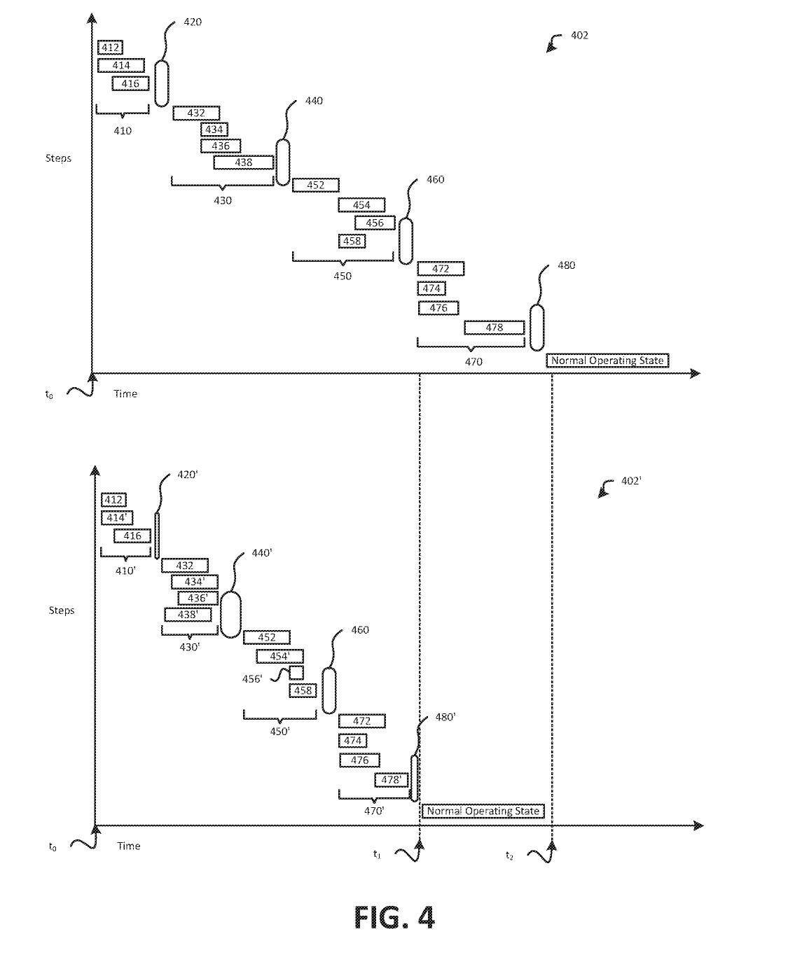

Referring to FIG. 4, block diagrams illustrating various aspects of exemplary embodiments for tuning a sequence of steps executed during an automated process for starting up an air separation plant are shown. In FIG. 4, an automated startup sequence 402 and an automated startup sequence 402′ are shown. In an embodiment, the automated startup sequence 402 may be a default automated startup sequence and the automated startup sequence 402′ may correspond to the automated startup sequence 402 after tuning has occurred. As shown in FIG. 4, the automated startup sequence 402 includes a first step 410, a first hold 420, a second step 430, a second hold 440, a third step 450, a third hold 460, a fourth step 470, and a fourth hold 480, where the air separation plant enters a normal operating state following the fourth hold 480. The first step 410 may include a first plurality of actions 412, 414, 416, the second step 430 may include a second plurality of actions 432, 434, 436, 438, the third step 450 may include a third plurality of actions 452, 454, 456, 458, and the fourth step 470 may include a fourth plurality of actions 472, 474, 476, 478. In an embodiment, one or more of the actions may be associated with a startup action, a ramping action, an observation action, a loading action, another action described elsewhere in the present disclosure, or a combination thereof.

As shown in FIG. 4, the automated startup sequence 402′ (e.g., the tuned automated startup sequence) includes a first step 410′, a first hold 420′, a second step 430′, a second hold 440′, a third step 450′, a third hold 460, a fourth step 470′, and a fourth hold 480′, where the air separation plant enters a normal operating state following the fourth hold 480′. In an embodiment, the first step 410′ may include a first plurality of actions 412, 414′, 416, where the action 412 corresponds to the action 412 without tuning, the action 414′ corresponds to the action 414 after tuning (e.g., to reduce the duration of the action 414), and the action 416 corresponds to the action 416 without tuning. In an embodiment, the first hold 420′ corresponds to the first hold 420 after tuning to reduce the duration of the first hold, as indicated by the reduced width of the first hold 420′ relative to the width of the first hold 420.

In an embodiment, the second step 430 may include a second plurality of actions 432, 434′, 436′, 438′, where the action 432 corresponds to the action 432 without tuning, the action 434′ corresponds to the action 434 after tuning (e.g., to increase the duration of the action 414 and to initiate the action 414 sooner), the action 436′ corresponds to the action 436 after tuning (e.g., to alter the timing for initiating the action 436), and the action 438′ corresponds to the action 438 after tuning (e.g., to reduce the duration of the action 438 and to initiate the action 438 simultaneously with the action 432). In an embodiment, the second hold 440′ corresponds to the second hold 440 after tuning to increase the duration of the second hold, as indicated by the increased width of the second hold 440′ relative to the width of the second hold 440.

In an embodiment, the third step 450 may include a third plurality of actions 452, 454′, 456′, 458, where the action 452 corresponds to the action 452 without tuning, the action 454′ corresponds to the action 454 after tuning (e.g., to initiate execution of the action 454 partially concurrently with respect to the action 452, rather than sequentially, as in the automated startup sequence 402), the action 456′ corresponds to the action 456 after tuning (e.g., to reduce the duration of the action 456), and the action 458 corresponds to the action 458 without tuning (e.g., the action 458 is still initiated sequentially upon completion of the action 452). In an embodiment, the third hold 460 corresponds to the third hold 460 without tuning.

In an embodiment, the fourth step 470 may include a fourth plurality of actions 472, 474, 476, 478′, where the actions 472, 474, and 476 corresponds to the actions 472, 474, and 476 without tuning, and the action 478′ corresponds to the action 478 after tuning (e.g., to increase the duration of the action 414 and to initiate the action 414 partially concurrently with respect to the actions 472 and 476, rather than sequentially). In an embodiment, the fourth hold 480′ corresponds to the fourth hold 480 after tuning to reduce the duration of the fourth hold, as indicated by the decreased width of the fourth hold 480′ relative to the width of the fourth hold 480.

In an embodiment, the various modifications made to the automated startup sequence 402 by the tuning described above may have been determined based on observations made during execution of the automated startup sequence 402. That is, the automated startup sequence 402 may have been initially executed as shown at 402, and, during execution of the automated startup sequence 402 various observations may have been made (e.g., by the process control sequencer 240 of FIG. 2). Based on information obtained from the observations, the automated startup sequence 402 was tuned to generate the automated startup sequence 402′, and subsequent startups of the air separation plant may be executed using the automated startup sequence 402′, rather than the automated startup sequence 402, which may significantly reduce the amount of time required to start up the air separation plant. For example, testing has demonstrated that startup time for an air separation plant can be reduced by at least 30% using an automated startup sequence that has been tuned in accordance with one or more embodiments of the present disclosure. It is noted that although each of the steps illustrated in FIG. 4 includes at least one action that has not been tuned and at least one action that has been tuned, in some embodiments, all actions for one or more steps may be tuned, or no actions for one or more steps may be tuned depending on the information and behaviors observed during execution of the automated startup sequence.

Referring to FIG. 5, a block diagram of illustrating aspects of an exemplary graphical user interface (GUI) for monitoring and controlling an automated startup process for an air separation plant is shown as a GUI 500. As shown in FIG. 5, the GUI 500 may present various information to a plant operator, such as startup sequence information 510, permissive information 520, permissive status information 530, action information 540, action status information 550, sequence tuning tools 560, and component status information 570. In an embodiment, the startup sequence information 510 may present information indicating a current step of the sequence of steps that is being executed, and may include information indicating the total number of steps included in the sequence of steps.

The permissive information 520 may present a list of permissives associated with a step in the sequence of steps. In an embodiment, the permissive information 520 may include information indicating one or more permissives that were monitored during a prior step (e.g., permissives that had to be passed to begin the step that is currently executing). In an additional or alternative embodiment, the permissive information 520 may include information indicating one or more permissives that are being actively monitored to determine when to execute a next step in the sequence of steps (e.g., permissives that have to be passed to begin the step that comes after the currently executing step). In another additional or alternative embodiment, the permissive information 520 may include information indicating one or more permissives that were monitored during a prior step, and information indicating one or more permissives that are being actively monitored to determine when to execute a next step in the sequence of steps. The permissive status information 530 may present information indicating a current status of the various permissives presented in connection with the permissive information 520. When the permissive information 520 presents information representative of permissives that must be passed prior to executing the next step in the sequence of steps, the permissive status information may indicate a current status of the various permissives. For example, if the next step requires a MAC (e.g., the MAC 204 of FIG. 2) to be loaded, the permissives information 520 may indicate that the MAC needs to be loaded, and the permissive status information 530 may indicate a current status of the loading of the MAC.

The action information 540 may present a list of actions associated with the step that is currently executing. The action status information 550 may present information that is representative of the current status of each of the actions being executed. For example, if an action corresponds to ramping a valve from one hundred percent (100%) closed to fifty percent (50%) open, the action status information 550 may present percentage information indicating the current opening of the valve. Other examples of information that may be presented in the action status information may include various parameters such as pressures, flow rates, temperatures, information indicating an action has completed, delay time information, hold time information, flow direction, and the like.

The sequence tuning tools 560 may provide the plant operator with the ability to dynamically adjust one or more of the operations of the automated startup sequence. For example, the sequence tuning tools 560 may enable the plant operator to lengthen or shorten the duration of a hold or delay, remove a hold or delay, impose a hold or delay, increase or reduce a ramping rate, change a target setpoint, or perform other adjustments to tune the automated startup sequence. The component status information 570 may indicate a current operational status of one or more of the components of the air separation plant. In an embodiment, the component status information 570 may present status information associated with components being monitored in connection with the permissives listed in the permissives information 520 and/or the components being monitored in connection with actions listed in the action information 540. In an additional or alternative embodiment, the component status information 570, or another screen presented by the GUI 500, may present a diagram representative of the components of the air separation plant, such as the diagram illustrated in FIG. 2. In an embodiment, information representative of the operational status of the components may be presented by color coding one or more portions of the diagram. For example, a first color (e.g., green) may be used to show that the flow of the air stream is traveling in a first direction (e.g., forward), and a second color (e.g., brown) may be used to show that the flow of the air stream is traveling in a second direction (e.g., backward). As air stream paths change direction, or as paths are opened and/or closed, the colors of the respective paths may change colors to visually indicate the current operational status of the paths.

In an embodiment, the GUI 500 may be updated as each step in the sequence of steps is completed. For example, when a first step is completed, the startup sequence information 510, the permissive information 520, the permissive status information 530, the action information 540, the action status information 550, the sequence tuning tools 560, and the component status information 570 may be updated to present corresponding information for the next step in the sequence of steps. A plant operator may view the information presented in the GUI 500 during execution of the startup sequence and, based on the presented information, may “tune” the sequence of steps as may be appropriate using the sequence tuning tools 560, for example. In an embodiment, the process control sequencer may also dynamically “tune” the startup sequence based on information it observes. For example, if the process control sequencer determines that all permissives for the next step or action have been completed, but that one or more delay timers have not expired, the process control sequencer may reduce the delay timer, or prompt the plant operator to confirm that the delay timer should be reduced. It is noted that the GUI 500 of FIG. 5 is provided for purposes of illustration, rather than by of limitation, and that other GUIs presenting less information or more information than is illustrated in FIG. 5 may be used with a process control sequencer configured according to the various embodiments disclosed herein.

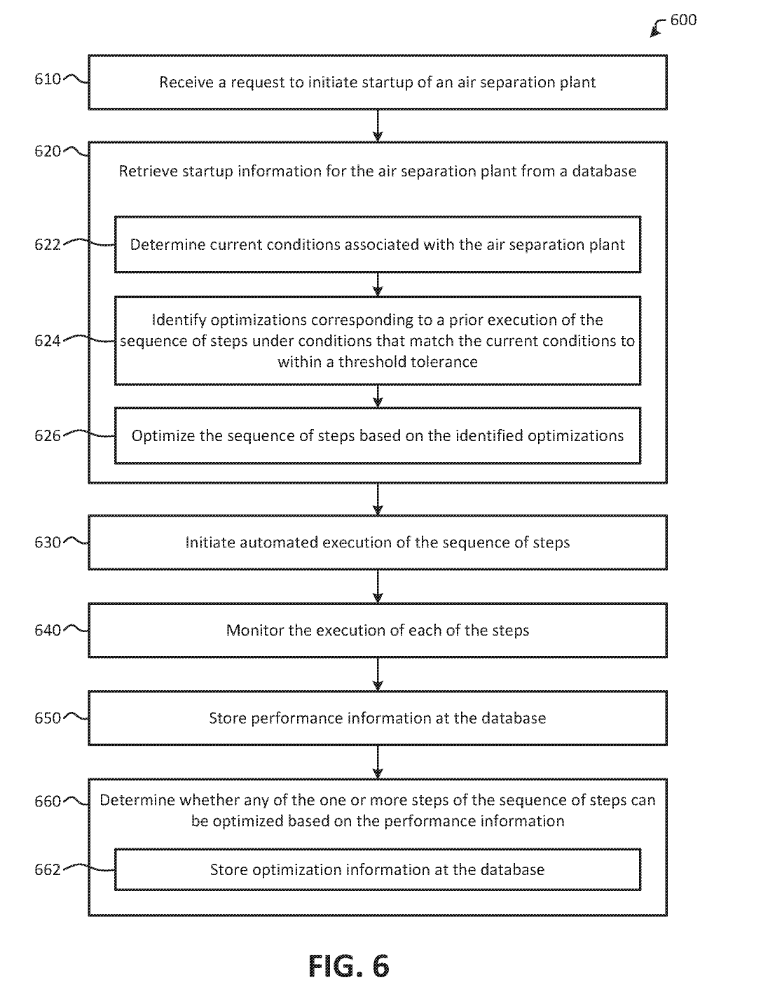

Referring to FIG. 6, a flow diagram of illustrating an exemplary method for automating startup of an air separation plant in accordance with one or more embodiments of the present disclosure is shown as a method 600. In an embodiment, the method 600 may be performed by a process control sequencer (e.g., the process control sequencer 240 of FIG. 2). In an embodiment, the method 600 may be stored as instructions (e.g., the instructions 246 of FIG. 2) that, when executed by a processor (e.g., the processor 242 of FIG. 2), cause the processor to perform operations for controlling an automated startup sequence for starting up an air separation plant.

At 610, the method 600 includes receiving a request to initiate startup of an air separation plant. In an embodiment, the request may be received via a graphical user interface (GUI), such as the GUI 300 of FIG. 3. In an additional or alternative embodiment, the request may be received in response to a plant operator depressing a button or activating a switch physically located at the air separation plant. In yet another additional or alternative embodiment, the request may be received from a plant operator that is remotely located with respect to the location of air separation plant. For example, a GUI (e.g., the GUI 500 of FIG. 5) may be presented to the plant operator while the plant operator is located remote from the air separation plant, and inputs received at the GUI may be communicated to the process control sequencer via a network, thereby allowing the plant operator to monitor and control the operations of the air separation plant remotely. For example, remotely located could include the plant operator being located in a different city from the plant. In response to receiving the command, operations to perform an automated startup sequence may be initiated. For example, at 620, the method 600 includes retrieving startup information for the air separation plant from a database. In an embodiment, the startup information may be the startup information described with reference to FIGS. 1 and 2, and the database may be the database 248 of FIG. 2. The startup information may include information identifying a sequence of steps to be automatically executed to start up the air separation plant, and may include information indicating an order of execution for the sequence of steps. In an embodiment, each step of the sequence of steps may be associated with one or more components of the air separation plant. In an embodiment, the startup information may include, for each step of the sequence of steps, one or more actions to be automatically completed and a set of permissives corresponding to the one or more actions. The set of permissives for each step may specify one or more parameters for controlling the execution of the action corresponding to one of the steps, as described in more detail above.

In an embodiment, the method 600 may include, at 622, determining current conditions associated with the air separation plant. In an embodiment, the current conditions associated with the air separation plant may include ambient conditions, utility conditions, equipment characteristics and sizes, instrumentation characteristics, control valve characteristics and sizes, modes of operation, etc., as described above with reference to FIG. 2. In response to determining the current conditions, the method 600 may include, at 624, identifying optimizations corresponding to a prior execution of the sequence of steps under conditions that match the current conditions to within a threshold tolerance. For example, if the current conditions indicate that the ambient conditions at the air separation plant are warm (e.g., 90° F.), optimizations corresponding to a prior execution of the sequence of steps under warm ambient conditions within a threshold tolerance (e.g., ±10° F. or another tolerance value) may be identified. In an embodiment, the optimizations may be identified based on information stored in a database, such as the profile information stored in the database 248, as described with reference to FIG. 2. At 626, the method 600 may include optimizing the sequence of steps based on the identified optimizations. In an embodiment, optimizing the sequence may include modifying one or more hold times, one or more delay times, or other parameters, as described above with reference to FIG. 2. Modifying the startup sequence based on the identified optimizations may prolong the lifespan of one or more components of the air separation plant, and may reduce the startup time.

At 630, the method 600 includes initiating the automated execution of the sequence of steps. In an embodiment, the sequence of steps may be the optimized sequence of steps determined at 622-626. At 640, the method 600 may include monitoring execution of each of the steps. In an embodiment, monitoring the execution of each of the steps may include monitoring the current status of each of the actions being executed, such as to determine flow rates, operational status information of one or more components (e.g., load of the MAC), pressures at various points or components, temperatures of one or more components, and the like. In an embodiment, the automated startup process may be halted if an error or malfunction (e.g., a failed sensor, a failed control element or valve, a failed utility supply, pressure levels falling below or rising above a threshold level, and the like) is detected during the monitoring. In such instances the startup sequence may be continued manually, or may be stopped until the malfunction or error is resolved. In an embodiment, if an error is detected, the method 600 may include generating an alert and/or an alarm. For example, if pressure levels at a component of the air separation plant keep rising after reaching a threshold level, the method 600 may generate an alarm message, such as a pop-up message displayed within the GUI 500 of FIG. 5, a text message to the plant operator's mobile device, or another form of notification, and/or may generate an alarm, such as an audible sound, a visual alarm (e.g., a flashing light, displaying a diagram of the air separation plant with the components associated with the error flashing in a certain color, such as red, etc.), or another form of alarm, or a combination of alarm messages and alarm(s) to notify the plant operator of the error. In an embodiment, the alarm(s) may prompt the plant operator to intervene and take control of whether the startup process continues, whether the startup process is halted, or whether the air separation plant is shutdown. In an additional or alternative embodiment, embodiment, the alarm(s) may notify the plant operator that operations to shut down the air separation plant have been automatically initiated in response to detecting the error.

At 650, the method 600 may include storing performance information at the database. The performance information may generated based at least in part on the monitoring and may include metrics representative of the operational status of one or more components of the air separation plant during execution of each step of the sequence of steps. At 660, the method 600 may include determining whether any of the one or more steps of the sequence of steps can be optimized based on the performance information. In an embodiment, the optimizations may be determined based on inputs received via the GUI (e.g., using the sequence tuning tools 360 of FIG. 3). In an additional or alternative embodiment, the optimizations may be dynamically determined by a process control sequencer, such as the process control sequencer 240 of FIG. 2. In response to a determination that at least one step of the one or more steps can be optimized, the method 600 may include, at 662, storing optimization information at the database. In an embodiment, the optimization information may be stored as a profile (e.g., one of the profiles described with reference to FIG. 2).

In an embodiment, the method 600 may include determining a production requirement for the air separation plant, and/or a purity requirement for the output(s) of the air separation plant, and configuring the automated startup sequence based on the production and/or purity requirement(s). For example, if the production requirement is ninety percent (90%) of the maximum production capacity for the air separation plant, the method 600 may configure the automated startup sequence to ramp up production at the air separation plant such that, when the automated startup is complete, the air separation plant is operating in a steady state of operation and is loaded to ninety percent (90%) of its maximum load/capacity. This may reduce the operating expenses for the air separation plant and improve the efficiency of the air separation plant. In an embodiment, the process control sequencer executing the method 600 may utilize performance prediction simulation software to predict a loading of the air separation plant that is sufficient to meet the production and/or purity requirement(s).

Executing an automated startup sequence in accordance with the method 600 may increase the reliability of the execution of the startup sequence of the air separation plant. Additionally, the method 600 may reduce the total time required to startup the air separation plant by at least 30% compared to startup procedures presently used, and may increase the life span of the various components of the air separation plant. Further, executing an automated startup sequence in accordance with the method 600 may reduce the operating expenses for the air separation plant, reduce risk to plant operators, and may reduce or eliminate the need to have personnel on site during at least a portion of the startup sequence execution. This may be beneficial for startups of air separation plants that are located in remote and/or dangerous areas, or in certain environments where operator onsite time has to be minimized due to health concerns. It is noted that although the method 600 and the various embodiments described in connection with FIGS. 1-6 are described with reference to startup of an air separation plant, one or more aspects of the various embodiments disclosed herein may also be used to perform an automated shutdown of the air separation plant. Further, although the present embodiments have been described in connection with the operations of an air separation plant, one of ordinary skill in the art may readily adapt various aspects of the embodiments of the present disclosure to other facilities, machines, and devices associated with complicated startup sequences. For example, liquefaction plants, steam methane reformers (SMRs), HYCO plants (syngas plants), and the like have startup processes and components that are similar, but not necessarily identical, to the startup processes and components of an air separation plant as described above with reference to FIGS. 1-6. Thus, embodiments of the present disclosure are well suited for automating and optimizing the startup of such structures.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method for controlling startup of an air separation plant, the method comprising:
receiving, by a processor, a request to initiate startup of an air separation plant;
in response to receiving the request, retrieving, by the processor, startup information for the air separation plant, wherein the startup information includes information identifying a sequence of steps to be automatically executed to start up the air separation plant, wherein each step of the sequence of steps is associated with a component of the air separation plant, and wherein the startup information includes, for each step of the sequence of steps, an action to be automatically completed and a set of permissives corresponding to the action, the set of permissives for each action specifying one or more parameters for controlling the execution of the corresponding action;
automatically initiating execution of the sequence of steps;
monitoring execution of one or more of the steps; and
determining, based on the monitoring, whether to modify one or more steps based on the monitoring.

2. The method of claim 1, wherein the information identifying the sequence of steps includes information indicating an order of execution for the sequence of steps.

3. The method of claim 2, wherein the set of permissives corresponding to a particular step include one or more parameters indicating threshold values corresponding to a prior step, and wherein the monitoring includes:
monitoring the one or more parameters during execution of the prior step to determine whether values of the one or more parameters satisfy the threshold values; and
executing the particular step in response to a determination that the values of the one or more parameters satisfy the threshold values.

4. The method of claim 3, wherein execution of the particular step of the sequence of steps begins prior to completing the execution of the prior step.

5. The method of claim 2, wherein information indicating the order of execution includes information indicating that two or more steps are to be executed concurrently, at least partially concurrently, or sequentially.

6. The method of claim 1, wherein an action is associated with a holding period, and wherein a duration of the holding period is adjustable based on information obtained during the monitoring.

7. The method of claim 1, wherein an action is associated with a ramping parameter that indicates a ramp rate at which a particular component of the air separation plant should be brought to a particular operation state in the startup process, and wherein the ramp rate is adjustable based on information obtained during the monitoring.

8. The method of claim 1, wherein an action is associated with a ramping parameter that indicates a target value at which a particular component of the air separation plant is to be brought to a particular operation state in the startup process, and wherein the target value is adjustable based on information obtained during the monitoring.

9. The method of claim 1, wherein an action is associated with a set of permissives corresponding to one or more parameters indicating threshold values prior to execution of an action, and wherein the threshold values are adjustable based on information obtained during the monitoring.

10. The method of claim 1, wherein the method includes:
determining, during execution of the sequence of steps, whether one or more interlocks of the air separation plant has been tripped; and
in response to a determination that at least one of the one or more interlocks has been tripped, terminating the execution of the sequence of steps to place the plant in a safe state.

11. The method of claim 1, wherein the method includes:
storing performance information in a database, wherein the performance information is generated based at least in part on the monitoring, wherein the performance information includes metrics representative of operational status of one or more components of the air separation plant during execution of each step of the sequence of steps;
determining one or more optimizations for the one or more steps of the sequence of steps based on the performance information; and
storing the optimizations in the database.

12. The method of claim 11, wherein the performance information includes data representative of conditions present during prior executions of the sequence of steps, and wherein the method includes:
determining current conditions;
identifying optimizations corresponding to a prior execution of the sequence of steps under conditions that match the current conditions to within a threshold tolerance;
optimizing the sequence of steps based on the identified optimizations; and
executing the optimized sequence of steps.

13. An apparatus for controlling startup of an air separation plant, the apparatus comprising:
at least one processor configured to:
receive a request to initiate startup of an air separation plant;
retrieve startup information for the air separation plant in response to receiving the request, wherein the startup information includes information identifying a sequence of steps to be automatically executed to start up the air separation plant and information indicating an order of execution for the sequence of steps, wherein each step of the sequence of steps is associated with a component of the air separation plant, and wherein the startup information includes, for each step of the sequence of steps, an action to be automatically completed and a set of permissives corresponding to the action, the set of permissives for each action specifying one or more parameters for controlling the execution of the corresponding action;
automatically initiate execution of the sequence of steps;
monitor execution of each of the steps;
store performance information in a database, wherein the performance information is generated based at least in part on the monitoring and includes metrics representative of operational status of one or more components of the air separation plant during execution of each step of the sequence of steps;
determine one or more optimizations for one or more steps of the sequence of steps based on the performance information; and
store the optimizations in the database; and
a memory coupled to the at least one processor.

14. The apparatus of claim 13, wherein the set of permissives corresponding to a particular step include one or more parameters indicating threshold values corresponding to a prior step, and wherein the at least one processor is configured to:
monitor the one or more parameters during execution of the prior step to determine whether values of the one or more parameters satisfy the threshold values; and
execute the particular step in response to a determination that the values of the one or more parameters satisfy the threshold values.

15. The apparatus of claim 13, wherein information indicating the order of execution includes information indicating that two or more steps are to be executed sequentially, concurrently, or at least partially concurrently.

16. The apparatus of claim 13, wherein an action is associated with a holding period, and wherein a duration of the holding period is adjustable based on information obtained during the monitoring.

17. The apparatus of claim 13, wherein an action is associated with a ramping parameter that indicates a ramp rate at which a particular component of the air separation plant should be brought to a particular operation state in the startup process, and wherein the ramp rate is adjustable based on information obtained during the monitoring.

18. The apparatus of claim 13, wherein an action is associated with a ramping parameter that indicates a target value at which a particular component of the air separation plant is to be brought to a particular operation state in the startup process, and wherein the target value is adjustable based on information obtained during the monitoring.

19. The apparatus of claim 13, wherein an action is associated with a set of permissives corresponding to one or more parameters indicating threshold values prior to execution of an action, and wherein the threshold values are adjustable based on information obtained during the monitoring.

20. The apparatus of claim 13, wherein the at least one processor is further configured to:
determining, during execution of the sequence of steps, whether one or more interlocks of the air separation plant has been tripped; and
in response to a determination that at least one of the one or more interlocks has been tripped, terminating the execution of the sequence of steps to place the plant in a safe state.

21. The apparatus of claim 13, wherein the performance information includes data representative of conditions present during prior executions of the sequence of steps, and wherein the at least one processor is configured to:
determine current conditions;
identify optimizations corresponding to a prior execution of the sequence of steps under conditions that match the current conditions to within a threshold tolerance;
optimize the sequence of steps based on the identified optimizations; and
initiate execution of the optimized sequence of steps.

22. A non-transitory computer-readable storage medium storing instructions that, when executed by a processor, cause the processor to perform operations for controlling startup of an air separation plant, the operations comprising:
receiving a request to initiate startup of an air separation plant;
in response to receiving the request:
retrieving, by the processor, startup information for the air separation plant from a database, wherein the startup information includes information identifying a sequence of steps to be automatically executed to start up the air separation plant and information indicating an order of execution for the sequence of steps, wherein each step of the sequence of steps is associated with a component of the air separation plant, and wherein the startup information includes, for each step of the sequence of steps, at least an action to be automatically completed and a set of permissives corresponding to the action, the set of permissives for each action specifying one or more parameters for controlling the execution of the corresponding action;
determining current conditions associated with the air separation plant;
identifying optimizations corresponding to a prior execution of the sequence of steps under conditions that match the current conditions to within a threshold tolerance; and
optimizing the sequence of steps based on the identified optimizations;
initiating automatic execution of the optimized sequence of steps;
monitoring execution of each of the steps;
storing performance information in the database, wherein the performance information is generated based at least in part on the monitoring and includes metrics representative of operational status of one or more components of the air separation plant during execution of each step of the sequence of steps;
determining whether any of the one or more steps of the sequence of steps can be further optimized based on the performance information; and
in response to a determination that one or more steps can be optimized, storing optimization information in the database.

23. The non-transitory computer-readable storage medium of claim 22, wherein the set of permissives corresponding to a particular step include one or more parameters indicating threshold values corresponding to a prior step, and wherein the monitoring includes:
monitoring the one or more parameters during execution of the prior step to determine whether values of the one or more parameters satisfy the threshold values; and
executing the particular step in response to a determination that the values of the one or more parameters satisfy the threshold values.

24. The non-transitory computer-readable storage medium of claim 22, wherein information indicating the order of execution includes information indicating that two or more steps are to be executed sequentially, concurrently, or at least partially concurrently.

25. The non-transitory computer-readable storage medium of claim 22, wherein an action is associated with a holding period, and wherein a duration of the holding period is adjustable based on information obtained during the monitoring.

26. The non-transitory computer-readable storage medium of claim 22, wherein an action is associated with a ramping parameter that indicates a ramp rate at which a particular component of the air separation plant should be brought to a particular operation state, and wherein the ramp rate is adjustable based on information obtained during the monitoring.

27. The non-transitory computer-readable storage medium of claim 22, wherein an action is associated with a ramping parameter that indicates a target value at which a particular component of the air separation plant is to be brought to a particular operation state in the startup process, and wherein the target value is adjustable based on information obtained during the monitoring.

28. The non-transitory computer-readable storage medium of claim 22, wherein an action is associated with a set of permissives corresponding to one or more parameters indicating threshold values prior to execution of an action, and wherein the threshold values are adjustable based on information obtained during the monitoring.

29. The non-transitory computer-readable storage medium of claim 22, wherein the operations include:
determining, during execution of the sequence of steps, whether one or more interlocks of the air separation plant has been tripped; and
in response to a determination that at least one of the one or more interlocks has been tripped, terminating the execution of the sequence of steps to place the plant in a safe state.
